(19) United States
(12) Patent Application Publication
(10) Pub. No.: US 2025/0307168 A1
(43) Pub. Date: Oct. 2, 2025

(54) DETECTING HOST WRITE PATTERNS FOR IMPROVING STORAGE MEDIA ENDURANCE

(71) Applicant: MICRON TECHNOLOGY, INC., Boise, ID (US)

(72) Inventor: Luca Bert, Bologna (IT)

(21) Appl. No.: 19/046,682

(22) Filed: Feb. 6, 2025

Related U.S. Application Data
(60) Provisional application No. 63/569,962, filed on Mar. 26, 2024.

(51) Int. Cl. G06F 12/0891; G06F 12/02; G06F 13/16

(52) U.S. Cl. CPC G06F 12/0891; G06F 12/0246; G06F 13/1642

(57) ABSTRACT

An example memory sub-system includes a memory device and a processing device, operatively coupled to the memory device. The processing device is configured to receive, from a host system, a memory write request specifying a data item to be stored on the memory device; identify a start logical address and an end logical address associated with the data item; responsive to determining that at least one of the start logical address or the end logical address is not aligned with a respective indirection unit (IU), store a corresponding misaligned portion of the data item in a cache line; and store an identifier of the respective IU in a metadata item associated with the cache line.

### REFERENCE TO RELATED APPLICATION

This application claims the priority benefit of U.S. Provisional Patent Application No. 63/569,962, filed Mar. 26, 2024, the entirety of which is incorporated herein by reference.

### TECHNICAL FIELD

Implementations of the disclosure are generally related to memory sub-systems, and more specifically, are related to methods of detecting host write patterns for improving storage media endurance.

### BACKGROUND

A memory sub-system may include one or more memory devices that store data. The memory devices may be, for example, non-volatile memory devices and volatile memory devices. In general, a host system may utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of some implementations of the disclosure.

FIG. 1 illustrates an example computing system that includes a memory sub-system in accordance with aspects of the present disclosure.

FIG. 2 schematically illustrates misaligned host writes caused by differences in the address granularity between the host and the memory sub-system operating in accordance with aspects of the present disclosure.

FIG. 3 schematically illustrates an example cache structure utilized for caching misaligned portions of host data by the memory sub-system operating in accordance with aspects of the present disclosure.

FIG. 4 schematically illustrates example arrangements of misaligned host data portions performed by the memory sub-system operating in accordance with aspects of the present disclosure.

FIG. 5 is a flow diagram of an example method of detecting host write patterns for caching partial IUs, implemented by a controller (e.g., a memory sub-system controller or a local media controller) operating in accordance with aspects of the present disclosure.

FIG. 6 is a flow diagram of an example method of reassembling the cached portions of host data in a manner that attempts to match the host write patterns, implemented by a controller (e.g., a memory sub-system controller or a local media controller) operating in accordance with aspects of the present disclosure.

FIG. 7 is a block diagram of an example computer system in which implementations of the present disclosure may operate.

### DETAILED DESCRIPTION

Implementations of the present disclosure are directed to detecting host write patterns for improving storage media endurance.

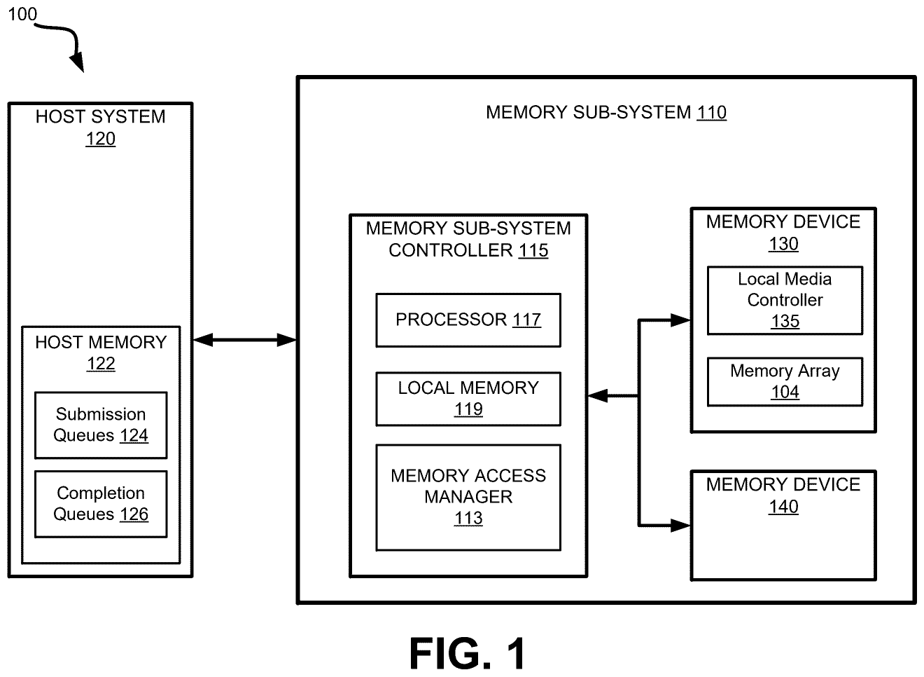

In general, a host system may utilize a memory sub-system that includes one or more components, such as memory devices that store data. The host system may provide data to be stored at the memory sub-system and may request data to be retrieved from the memory sub-system. A memory sub-system may include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die may include two or more planes. For some types of non-volatile memory devices (e.g., NAND devices), each plane includes a set of physical blocks. In some implementations, each block may include multiple sub-blocks. Each plane carries a matrix of memory cells formed onto a silicon wafer and joined by conductors referred to as wordlines and bitlines, such that a wordline joins multiple memory cells forming a row of the matric of memory cells, while a bitline joins multiple memory cells forming a column of the matric of memory cells.

Depending on the cell type, each memory cell may store one or more bits of binary information, and has various logic states that correlate to the number of bits being stored. The logic states may be represented by binary values, such as “0” and “1”, or combinations of such values. A set of memory cells referred to as a memory page may be programmed together in a single operation, e.g., by selecting consecutive bitlines.

Memory access operations (e.g., a programming (write) operation, an erase operation, etc.) may be executed with respect to sets of the memory cells, e.g., in response to receiving a memory access request from the host. A memory access request initiated by the host may specify the requested memory access operation (e.g., write, erase, read, etc.) and a logical address (e.g., represented by a logical block address (LBA) and an optional namespace identifier), which identifies the location that the host system associates with the data item to be read/written/erased by the requested memory access operation.

In order to isolate the host system from various aspects of physical implementations of memory devices employed by memory sub-systems, the memory sub-system may translate the logical address supplied by the host to a corresponding physical address identifying the physical location of the data item to be read/written/erased by the requested memory access operation. In some implementations, the physical address may include a channel identifier, a die identifier, a page identifier, a plane identifier and/or a frame identifier. The address translation may be facilitated by an address translation table (e.g., a logical-to-physical (L2P) table) maintained by the memory sub-system for mapping each indirection unit (IU) to a corresponding physical address.

As both memory device capacities and host storage size requirements have been growing, which lead to adaptation of large IUs and/or large system page sizes. “Large IU” herein refers to an IU having a size that is a multiple of the system page size supported by the host. Unless explicitly stated otherwise, implementations and examples described herein assume that large IUs are utilized.

Since the system page size is less than the IU size, the host would be able to issue memory access requests that are not aligned with the IU boundaries, thus triggering otherwise unnecessary read-modify-write (RMW) operations, which may adversely affect the media endurance and lifetime. For example, using the page size of 4 KB and the IU size of 16 KB, every host write of 4 KB would force the memory sub-system to read-modify-write the entire IU (16 KB) by reading the entire IU (16 KB), modifying the relevant part (4 KB), and writing back the entire IU (16 KB).

In an illustrative example, the host may have a file system that appends metadata to the file data, e.g., by using 512 KB extents, of which 508 KB are occupied by the file data and the remaining 4 KB are reserved for the metadata. In such a scenario, the host may issue two write requests: one request to write 508 KB of file data, which would trigger an RMW operation at the last IU, followed by another request to write 4 KB of metadata, which would trigger another RMW operation at the same IU. Notably, those two RMW operations may have been avoided if the memory sub-system was capable of detecting the association between the two write requests.

Implementations of the present disclosure address the above-noted and other challenges by enabling the memory sub-system to detect host write patterns while using large IUs.

As noted herein above, the IU size exceeding the system page size may result in at least some host-initiated write requests specifying data items having their start logical address and/or their end logical address misaligned with the corresponding IUs. In an illustrative example, the start logical address of the data item to be written to a non-volatile memory device may be misaligned with the corresponding IU boundary. In another illustrative example, the end logical address of the data item to be written to the non-volatile memory device may be misaligned with the corresponding IU boundary.

In order to minimize the number of the read-modify-write operations caused by misaligned host writes, portions of the host data corresponding to the partial IUs may be cached by a volatile memory device (while the portions of the host data corresponding to the full IUs may be written to the non-volatile memory device) and the cached partial IUs may be later reassembled in an attempt to detect and follow host write patterns.

In the absence of any explicit host execution thread-identifying metadata supplied by the host, the memory sub-system may utilize the submission queue identifiers as the proxy for the host thread identifiers. Accordingly, the memory sub-system controller may logically associate, with each submission queue, a respective set of cache lines (e.g., residing in a volatile memory, such as DRAM) that would be utilized for storing portions of the data corresponding to the partial IUs associated with write commands retrieved from that submission queue.

For each portion of host data stored in a particular cache line, the memory sub-system controller may store, in an associated metadata item, the corresponding IU identifier (e.g., represented by the truncated LBA, as described in more detail herein below). The memory sub-system controller may periodically scan the cache metadata in order to identify cache lines that sore portions of host data associated with matching IU addresses.

If the portions of host data stored in the identified cache lines that are associated with the same IU address form a complete IU, the controller may store those portions of host data on the non-volatile memory device and invalidate the identified cache lines. Conversely, if the portions of host data stored in the identified cache lines associated with the same IU address do not form a complete IU, the controller may store those portions of host data in a single cache line (e.g., in one of the identified cache lines) and invalidate the other identified cache lines.

Thus, advantages of the systems and methods implemented in accordance with implementations of the present disclosure include detecting host write patterns for improving storage media endurance.

Various aspects of the methods and systems are described herein by way of examples, rather than by way of limitation. The systems and methods described herein can be implemented by hardware (e.g., general purpose and/or specialized processing devices, and/or other devices and associated circuitry), software (e.g., instructions executable by a processing device), or a combination thereof.

FIG. 1 illustrates an example computing system 100 that includes a memory sub-system 110 in accordance with some implementations of the present disclosure. The memory sub-system 110 may include one or more volatile memory devices 140 and/or one or more non-volatile memory devices 130.

A memory sub-system 110 may be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 may include a host system 120 that is coupled to one or more memory sub-systems 110. In some implementations, the host system 120 is coupled to different types of memory sub-system 110. FIG. 1 illustrates one example of a host system 120 coupled to one memory sub-system 110. As used herein, “coupled to” or “coupled with” generally refers to a connection between components, which may be an indirect communicative connection or direct communicative connection (e.g., without intervening components), whether wired or wireless, including connections such as electrical, optical, magnetic, etc.

The host system 120 may include a processor chipset and a software stack executed by the processor chipset. The processor chipset may include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 may be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface may be used to transmit data between the host system 120 and the memory sub-system 110. The host system 120 may further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface may provide an interface for passing control, address, data, and other signals between the memory sub-system 110 and the host system 120. FIG. 1 illustrates a memory sub-system 110 as an example. In general, the host system 120 may access multiple memory sub-systems via a same communication connection, multiple separate communication connections, and/or a combination of communication connections.

The memory devices 130, 140 may include any combination of the different types of non-volatile memory devices and/or volatile memory devices. The volatile memory devices (e.g., memory device 140) may be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory may perform bit storage based on a change of bulk resistance, in conjunction with a stackable cross-gridded data access array. Additionally, in contrast to many flash-based memories, cross-point non-volatile memory may perform a write in-place operation, where a non-volatile memory cell may be programmed without the non-volatile memory cell being previously erased. NAND type flash memory includes, for example, two-dimensional NAND (2D NAND) and three-dimensional NAND (3D NAND).

Each of the memory device(s) 130 may include one or more arrays of memory cells. One type of memory cell, for example, single level cells (SLC) may store one bit per cell. Other types of memory cells, such as multi-level cells (MLCs), triple level cells (TLCs), and quad-level cells (QLCs), may store multiple bits per cell. In some implementations, each of the memory devices 130 may include one or more arrays of memory cells such as SLCs, MLCs, TLCs, QLCs, or any combination of such. In some implementations, a particular memory device may include an SLC portion, and an MLC portion, a TLC portion, or a QLC portion of memory cells. The memory cells of the memory devices 130 may be grouped as pages that may refer to a logical unit of the memory device used to store data. With some types of memory (e.g., NAND), pages may be grouped to form blocks.

Although non-volatile memory components such as a 3D cross-point array of non-volatile memory cells and NAND type flash memory (e.g., 2D NAND, 3D NAND) are described, the memory device 130 may be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) may communicate with the memory device(s) 130 to perform operations such as reading data, writing data, or erasing data at the memory devices 130 and other such operations. The memory sub-system controller 115 may include hardware such as one or more integrated circuits and/or discrete components, a buffer memory, or a combination thereof. The hardware may include a digital circuitry with dedicated (i.e., hard-coded) logic to perform the operations described herein. The memory sub-system controller 115 may be a microcontroller, special purpose logic circuitry (e.g., a field programmable gate array (FPGA), an application specific integrated circuit (ASIC), etc.), or other suitable processor.

The memory sub-system controller 115 may include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some implementations, the local memory 119 may include memory registers storing memory pointers, fetched data, etc. The local memory 119 may also include read-only memory (ROM) for storing micro-code. While the example memory sub-system 110 in FIG. 1 has been illustrated as including the memory sub-system controller 115, in another implementation of the present disclosure, a memory sub-system 110 does not include a memory sub-system controller 115, and may instead rely upon external control (e.g., provided by an external host, or by a processor or controller separate from the memory sub-system).

In general, the memory sub-system controller 115 may receive commands or operations from the host system 120 and may convert the commands or operations into instructions or appropriate commands to achieve the desired access to the memory device(s) 130. The memory sub-system controller 115 may be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 may further include host interface circuitry to communicate with the host system 120 via the physical host interface. The host interface circuitry may convert the commands received from the host system into command instructions to access the memory device(s) 130 as well as convert responses associated with the memory device(s) 130 into information for the host system 120.

The memory sub-system 110 may also include additional circuitry or components that are not illustrated. In some implementations, the memory sub-system 110 may include a cache or buffer (e.g., DRAM) and address circuitry (e.g., a row decoder and a column decoder) that may receive an address from the memory sub-system controller 115 and decode the address to access the memory device(s) 130.

In some implementations, the memory device(s) 130 include local media controllers 135 that operate in conjunction with memory sub-system controller 115 to execute operations on one or more memory cells of the memory device(s) 130. An external controller (e.g., memory sub-system controller 115) may externally manage the memory device 130 (e.g., perform media management operations on the memory device(s) 130). In some implementations, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, may each represent a single die having some control logic (e.g., local media controller 135) embodied thereon. In some implementations, one or more components of memory sub-system 110 may be omitted.

In some implementations, the host system 120 utilizes a set of queues to track the memory access commands issued to the memory sub-system 110. For example, the host system 120 may maintain a set of submission queues 124, which store the memory access commands issued to the memory sub-system 110. In some implementations, the host system 120 may further maintain a set of completion queues 126, which store command completion statuses received from the memory sub-system 110 to indicate that the corresponding memory access commands have been executed. In some implementations, the host system 120 may maintain these queues in a host memory 122, such as a dynamic random access memory (DRAM) device or other memory device. Submission queues 124 and completion queues 126 may be implemented as circular buffers with a fixed slot size. In other implementations, there may be some other number of queues or queue pairs in host memory 122.

In some implementations, the memory sub-system 110 includes a memory access manager 113. In some implementations, the memory sub-system controller 115 includes at least a portion of the memory access manager 113. For example, the memory sub-system controller 115 may include a processor (processing device) 117 configured to execute instructions stored in local memory 119 for performing the operations described herein. In some implementations, the memory access manager 113 may receive and service the memory access requests initiated by the host system.

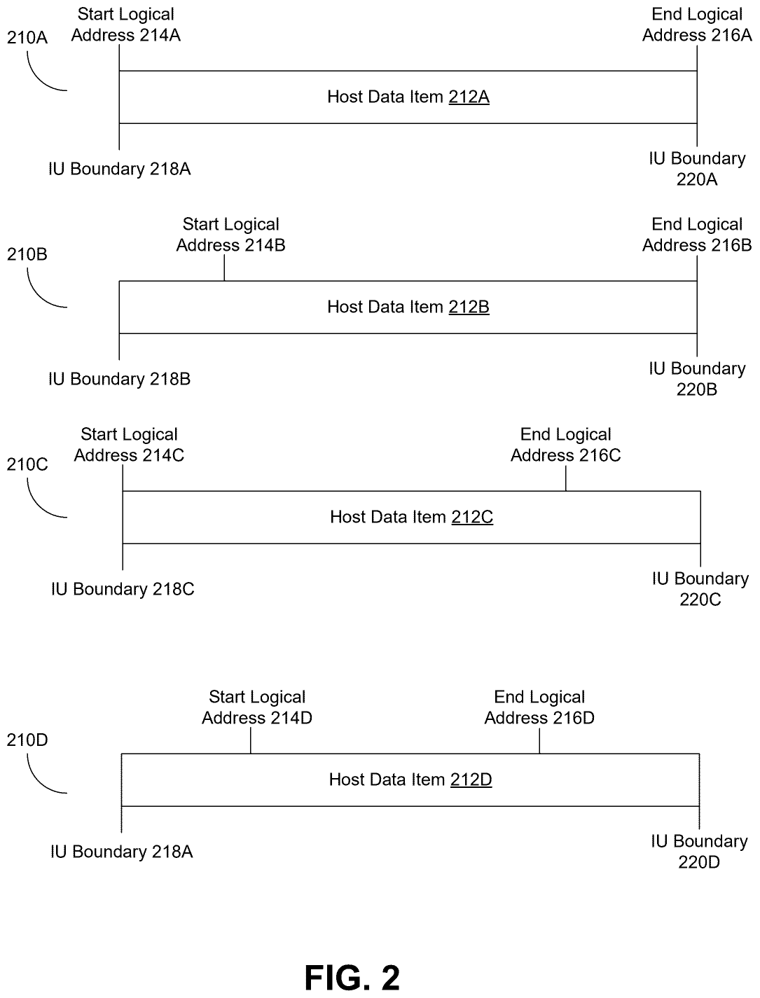

As noted herein above, the memory access manager 113 may, for allocating space on the non-volatile memory device(s) 130, utilize the IU size that is a multiple of the system page size utilized by the host system 120. This difference in the address granularity between the host and the memory sub-system may lead to misaligned host writes, as described below with reference to FIG. 2.

As schematically illustrated by FIG. 2, the host-initiated write command 210A specifies a data item 212A to be written to the non-volatile memory device(s) 130; both the start logical address 214A and the end logical address 216A of the data item 212A match the respective IU boundaries 218A and 220A. In other words, the size of the data item 212A matches (or is a multiple of) the size of the IU, and the starting logical address of the data item matches the IU boundary.

In another illustrative example, the host-initiated write command 210B specifies a data item 212B to be written to the non-volatile memory device(s) 130; while the end logical address 216B of the data item 212B matches the end IU boundary 220B, the start logical address 214B of the data item 212B is misaligned with respect to the start IU boundary 218B. In other words, the size of the data item 212B is a not a multiple of the size of the IU, which leads to the misalignment of the start logical address 214B with respect to the start IU boundary 218B.

In another illustrative example, the host-initiated write command 210C specifies a data item 212C to be written to the non-volatile memory device(s) 130; while the start logical address 214C of the data item 212C matches the start IU boundary 218C, the end logical address 216C of the data item 212C is misaligned with respect to the end IU boundary 220C. In other words, the size of the data item 212C is a not a multiple of the size of the IU, which leads to the misalignment of the end logical address 216C with respect to the start IU boundary 220C.

In another illustrative example, the host-initiated write command 210D specifies a data item 212D to be written to the non-volatile memory device(s) 130; both the start logical address 214D and the end logical address 216D of the data item 212D are misaligned relative to the respective IU boundaries 218D and 220D. In other words, the size of the data item 212D is a not a multiple of the size of the IU, which leads to the misalignment of both the start logical address 214D and the end logical address 216D relative to the respective IU boundaries 218D and 220D.

Thus, the host data to be written to the non-volatile memory device(s) 130 may include zero, one, or two portions that are misaligned with the respective IUs. In order to minimize the number of the read-modify-write operations caused by misaligned host writes, the memory access manager 113 may proceed to directly write, to the non-volatile memory device(s) 130, the portions of the host data that are fully aligned with the respective IUs may be written to the non-volatile memory device(s) 130; conversely, the portions of the host data that are misaligned relative to the respective IUs may be cached in a cache residing on the volatile memory device(s) 140 and later reassembled in a manner that attempts to match the host write patterns.

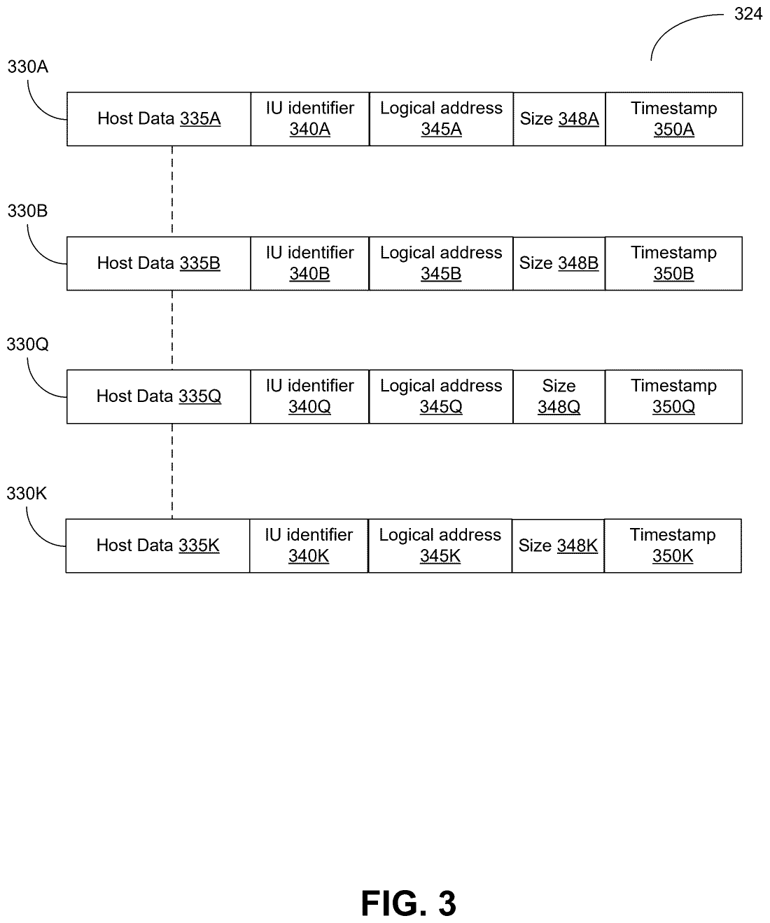

As noted herein above, in order to follow the host write patterns, the memory access manager 113 may utilize identifiers of the submission queues 124 as the proxy for identifiers of the host processing threads. In other words, each submission queue 124 may be presumed to be utilized by a corresponding host processing thread. Accordingly, as schematically illustrated by FIG. 3, the memory access manager 113 may logically associate, with each submission queue 124, a corresponding set of cache lines 324. The sets of cache lines 324 may reside on the volatile memory device(s) 140 (e.g., DRAM). Each set of cache lines 324 may include cache lines 330A-330K, such that each cache line can be utilized to store respective portion of host data 335A-335K corresponding to a respective partial IUs associated with a sequence of write commands initiated by the submission queue 124 that is logically associated with the set of cache lines 324.

For each portion of host data 335 stored in a particular cache line 330, the memory access manager 113 may store an associated metadata item containing the corresponding IU identifier (e.g., the truncated LBA). In some implementations, each cache line 330A-330K of a set of cache lines 324 may, in addition to the cached data 335A-335K, store one or more metadata items.

In an illustrative example, the metadata stored by the cache line 330B may include the identifier 340B of the IU (e.g., the truncated LBA) corresponding to the IU contents (the portion of host data 335B) stored in the cache line 330B. The IU identifier may be used, e.g., for identifying a matching host data item which may be stored in a different cache line, as described in more detail herein below.

In some implementations, the IU identifier may be represented by the logical address (e.g., the LBA) divided by two raised to the power of the ratio of the IU size and the system page size (e.g., divided by 4=2^{(8/4)} for the IU size of 8K, divide by 16=2^{(16/4)} for the IU size of 16K, etc.). This operation is equivalent to truncating the logical address (e.g., the LBA) by discarding a defined number of least significant bits. The number of least significant bits to be discarded equals the IU size divided by the system page size (e.g., 4=2^{(8/4)} for the IU size of 8K, 16=2^{(16/4)} for the IU size of 16K, etc.).

In another illustrative example, the metadata stored by the cache line 330B may include the original (untruncated) logical address (e.g., the LBA) 345B of the portion of host data 335B stored in the cache line 330B. The logical address may be used, e.g., for determining whether matching portions of host data form an entire IU, as described in more detail herein below.

In another illustrative example, the metadata stored by the cache line 330B may include the size 348B of the portion of host data 335B stored in the cache line 330B. The size may be used, e.g., for determining the end logical address of the portion of the host data item stored in the cache line 330B, as described in more detail herein below.

In another illustrative example, the metadata stored by the cache line 330B may include the timestamp 350B of the last modification of the cache line 330B. The timestamp may be utilized, e.g., for identifying a victim cache line for eviction, as described in more detail herein below.

As noted herein above, the host data to be written to the non-volatile memory device(s) 130 may include zero, one, or two portions that are misaligned with the respective IUs. Referring to the examples described above with reference to FIG. 2, the host write command 210A results in the perfect alignment of the host data with the IU boundaries and thus no portions of the host data will be cached. Conversely, each of the host write commands 210B and 210C results in a corresponding portion of the host data being misaligned with a respective UI boundary; this portion of the host data will thus be cached in a corresponding cache line. Furthermore, the host write command 210D results in one or more portions of the host data being misaligned relative to the two UI boundaries; these one or more portions of the host data will thus be cached in corresponding cache line(s).

Referring again to FIG. 3, in an illustrative example, the metadata item 340B contains the identifier (e.g., LBA=1000) of the IU, the contents of which are stored in the cache line 330B. A subsequent host write request may result in another misaligned data item falling within the same IU; this data item will then be stored in the cache line 330Q, and the metadata item 340Q will be updated to store the identifier (e.g., LBA=1000) of the IU.

As noted herein above, the cached portions of the host data that are misaligned relative to the respective IUs may be reassembled by the memory access manager in a manner that attempts to match the host write patterns. In some implementations, the memory access manager 113 may, for each submission queue, periodically scan the corresponding set of metadata items in order to identify subsets (e.g., pairs) of cache lines that store portions of host data associated with matching IU addresses. Notably, the cache lines forming such subsets may be scattered across the set of cache lines in a random or regular fashion (e.g., the cache line 330B and the cache line 330Q). Thus, the phrases “subset of cache lines” and “pair of cache lines” define logical groupings of cache lines based on the contents of respective metadata items associated with those cache lines and should not be interpreted as defining any particular physical arrangement of the cache lines within the set of cache lines.

Scanning the set of metadata may involve iterating over all possible combinations, such that each combination would include a predefined number (e.g., two) of metadata items storing the respective IU identifiers and comparing their respective values. In the above-described illustrative example, the metadata items 340B and 340Q store the same IU identifier (e.g., LBA=1000).

Once a subset (e.g., a pair) of matching metadata items (i.e., metadata items storing the same IU identifier) is identified, the memory access manager 113 may ascertain whether the portions of host data stored in the identified subset of cache lines form a complete IU. In an illustrative example, the portions of host data may be combined (e.g., concatenated) based on their respective logical addresses (which may be specified by metadata items 345A associated with respective cache lines). If the combined portions of host data do form a complete IU, the memory access manager 113 may store them on the non-volatile memory device(s) 130 and invalidate the cache lines that store those portions of host data.

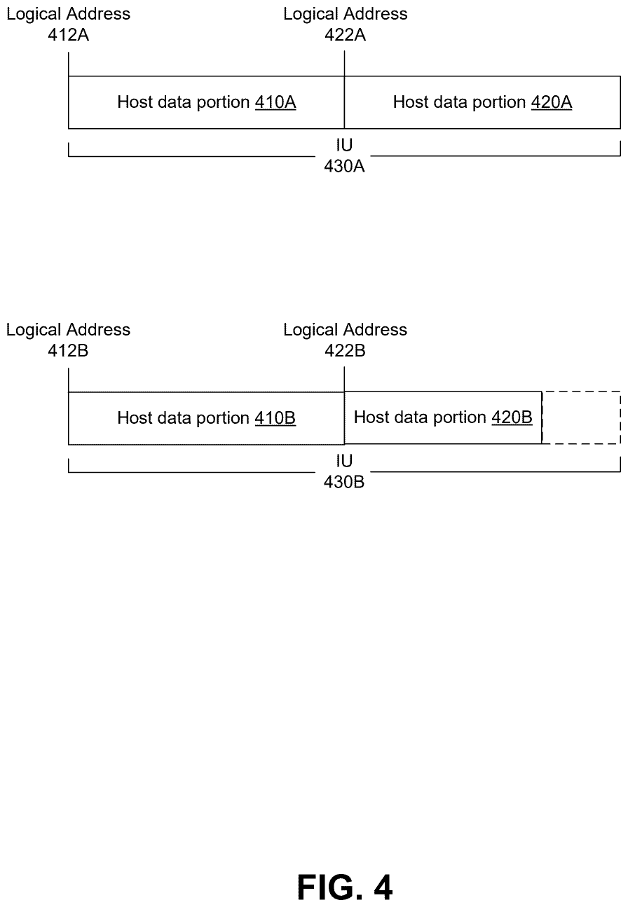

In the illustrative example of FIG. 4, the host data portions 410A and 420A, arranged according to their respective logical addresses 412A and 422A, form a complete IU 430A.

Conversely, if the combined portions of host data fail to form a complete IU, the memory access manager 113 may store the portions of host data in a single cache line (e.g., in one of cache lines forming the identified subset of cache lines) and invalidate the other identified cache lines.

In another illustrative example of FIG. 4, the host data portions 410B and 420B, arranged according to their respective logical addresses 412B and 422B, fail to form a complete IU 430B.

In some implementations, the memory access manager may implement various cache management strategies with respect to the sets of cache lines 324. In an illustrative example, responsive to failing to identify an available cache line for storing a new portion of host data corresponding to a partial IU, the memory access manager 113 may evict a cache line by storing its content on the non-volatile memory device(s) 130, and may further utilize the evicted cache line to store the new portion of host data. In some implementations, the least recently used cache line (identified based on the timestamp 350) may be evicted.

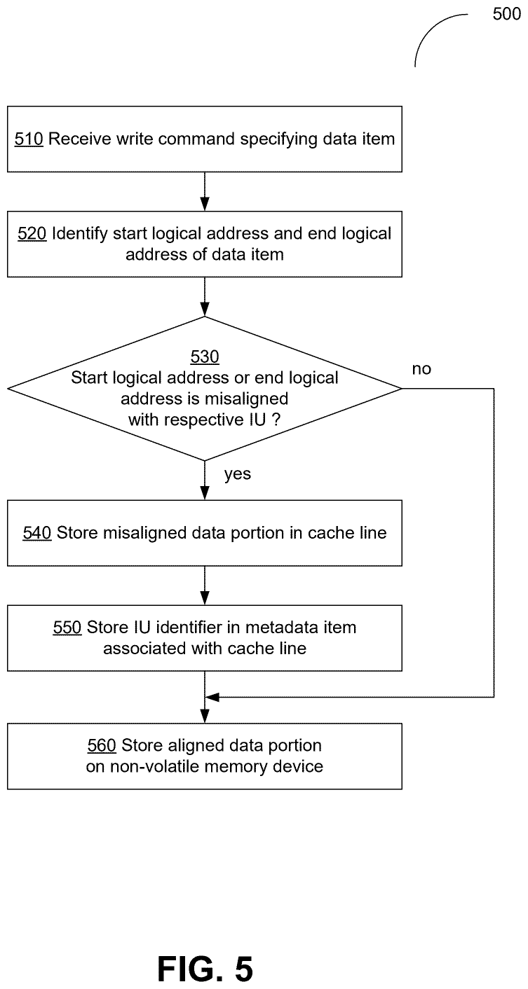

FIG. 5 is a flow diagram of an example method 500 of detecting host write patterns for caching partial IUs, implemented by a controller (e.g., a memory sub-system controller or a local media controller) operating in accordance with aspects of the present disclosure. The method 500 can be performed by processing logic that can include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other. In some embodiments, the method 500 is performed by the memory sub-system controller 115 and/or the local media controller 135 of FIG. 1. In some implementations, the method 500 is performed by the memory access manager 113. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 510, the controller implementing the method receives (e.g., from the host system) a memory write request specifying a data item to be stored on the memory device and a logical address of the data item, as described in more detail herein above.

At operation 520, the controller identifies the start logical address and the end logical address associated with the data item. While the start logical address may be specified by the memory access request, the end logical address may be identified by adding the data item size to the start logical address.

At operation 530, the controller determines whether the start logical address or the end logical address is not aligned with a respective indirection unit (IU). In an illustrative example, the identifier of the IU is determined by applying a predefined mathematical transformation to a corresponding logical address (e.g., the start logical address or the end logical address). In some implementations, the IU identifier may be represented by the logical address (e.g., the LBA) divided by two raised to the power of the ratio of the IU size and the system page size. This operation is equivalent to truncating the logical address (e.g., the LBA) by discarding a defined number of least significant bits. The number of least significant bits to be discarded equals the IU size divided by the system page size. Accordingly, the controller determines whether the start logical address and/or the end logical address of the data items would fall between the two IU boundaries, as described in more detail herein above.

Accordingly, responsive to determining, at operation 530, that the start logical address or the end logical address is not aligned with a respective indirection unit (IU), the processing continues at operation 540; otherwise, the method branches to operation 560.

At operation 540, the controller stores a corresponding misaligned portion of the data item in a cache line of a cache residing on a volatile memory device, as described in more detail herein above.

At operation 550, the controller stores an identifier of the respective IU (e.g., the truncated LBA) in a metadata item associated with the cache line. In some implementations, the controller may further store the logical address of the cached portion of the host data in a metadata item associated with the cache line. In some implementations, the controller may further store the last modification timestamp in a metadata item associated with the cache line, as described in more detail herein above.

At operation 560, the controller optionally stores the aligned portion(s) of host data (if such portions are found) on a non-volatile memory device, as described in more detail herein above. Upon completing the operation 560, the method terminates.

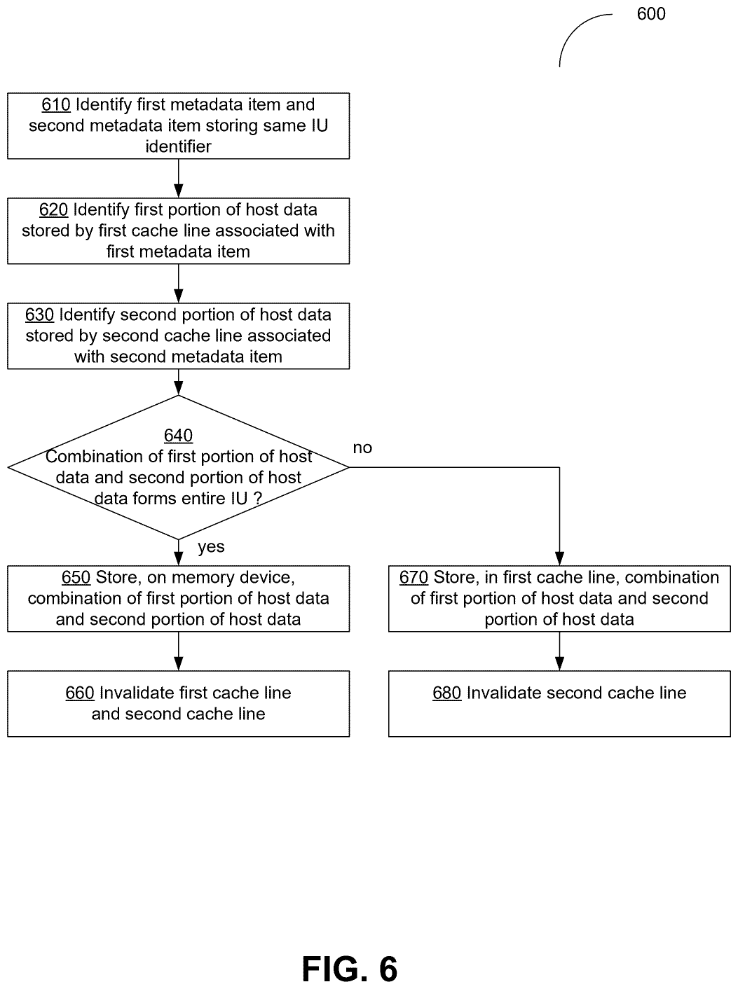

FIG. 6 is a flow diagram of an example method 600 of reassembling the cached portions of host data in a manner that attempts to match the host write patterns, implemented by a controller (e.g., a memory sub-system controller or a local media controller) operating in accordance with aspects of the present disclosure. The method 600 can be performed by processing logic that can include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other. In some embodiments, the method 600 is performed by the memory sub-system controller 115 and/or the local media controller 135 of FIG. 1. In some implementations, the method 600 is performed by the memory access manager 113. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 610, the controller implementing the method identifies, among the set of metadata items associated with a set of cache lines, a first metadata item and a second metadata item storing the same IU identifier. In an illustrative example, the controller may scanning the set of metadata items by iterating over all possible combinations, such that each combination would include a predefined number (e.g., two) of metadata items storing the respective IU identifiers, and comparing their respective values until a match is found or all possible combinations have been considered, as described in more detail herein above.

At operation 620, the controller identifies a first portion of host data stored by a first cache line associated with the first metadata item, as described in more detail herein above.

At operation 630, the controller identifies a second portion of host data stored by a second cache line associated with the second metadata item, as described in more detail herein above.

At operation 640, the controller determines whether a combination of the first and second portions of host data arranged according to their respective logical addresses forms an entire IU, as described in more detail herein above.

Responsive to determining, at operation 640, that the combination of the first and second portions of host data forms an entire IU, the processing continues at operation 650; otherwise, the method branches to operation 670.

At operation 650, the controller stores, on a non-volatile memory device, the combination of the first and second portions of host data arranged according to their respective logical addresses, as described in more detail herein above.

At operation 660, the controller invalidates the first cache line and the second cache line. Upon completing the operation 660, the method terminates.

At operation 670, the controller stores, in the first cache line, the combination of the first and second portions of host data arranged according to their respective logical addresses. In some implementations, the controller may further update one or more metadata items associated with the first cache line (e.g., the logical address of the portion of the host data, the size of the portion of the host data, and/or the last modification timestamp), as described in more detail herein above.

At operation 680, the controller invalidates the second cache line. Upon completing the operation 680, the method terminates.

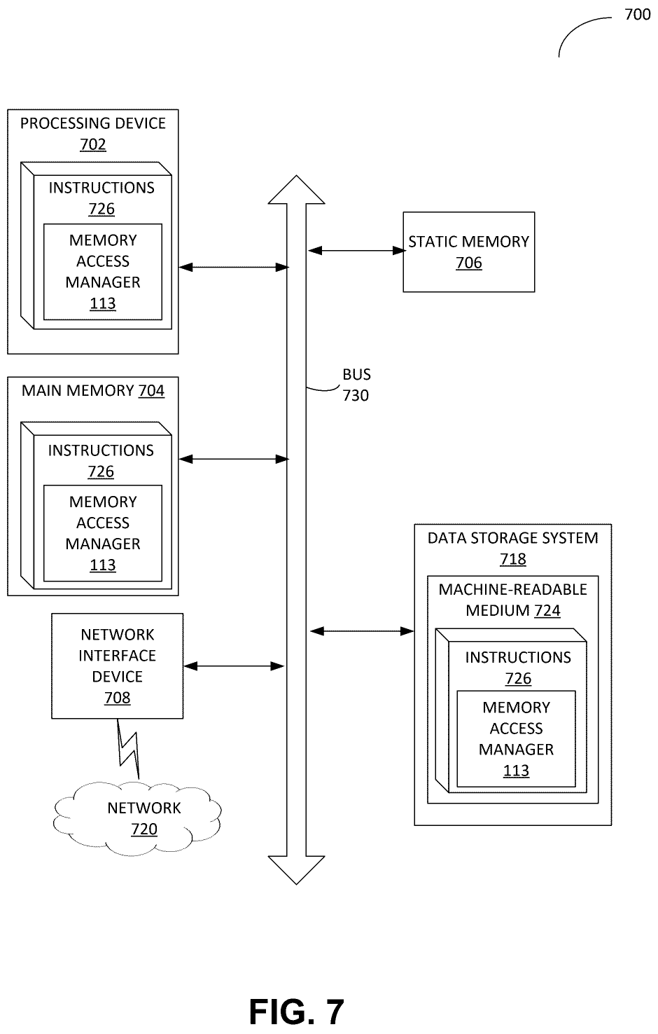

FIG. 7 illustrates an example machine of a computer system 700 within which a set of instructions, for causing the machine to perform any one or more of the methodologies discussed herein, may be executed. In some implementations, the computer system 700 may correspond to a host system (e.g., the host system 120 of FIG. 1) that includes, is coupled to, or utilizes a memory sub-system (e.g., the memory sub-system 110 of FIG. 1) or may be used to perform the operations of a controller (e.g., to execute an operating system to perform operations corresponding to the memory access manager 113 of FIG. 1). In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 may further include a network interface device 708 to communicate over the network 720.

The data storage system 718 may include a machine-readable storage medium 724 (also known as a computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 may correspond to the memory sub-system 110 of FIG. 1.

In some implementations, the instructions 726 include instructions to implement functionality corresponding to the memory access manager 113 of FIG. 1). While the machine-readable storage medium 724 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure may refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus may be specially constructed for the intended purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A system, comprising:
a memory device;
a processing device, operatively coupled to the memory device, to perform operations, comprising:
receiving, from a host system, a memory write request specifying a data item to be stored on the memory device;
identifying a start logical address and an end logical address associated with the data item;
determining that at least one of the start logical address or the end logical address is not aligned with a respective indirection unit (IU);
responsive to determining that the at least one of the start logical address or the end logical address is not aligned with the respective indirection unit (IU), storing a corresponding misaligned portion of the data item in a cache line; and
storing an identifier of the respective IU in a metadata item associated with the cache line.

2. The system of claim 1, wherein a size of the respective IU is a multiple of a size of a system page utilized by the host system.

3. The system of claim 1, wherein the memory write request is comprised by a sequence of memory access requests that is associated with a corresponding processing thread running on the host system.

4. The system of claim 1, wherein the memory write request is comprised by a sequence of memory access requests that is associated with a corresponding submission queue.

5. The system of claim 1, wherein the identifier of the respective IU is determined by applying a predefined mathematical transformation to a corresponding logical address represented by one of: the start logical address or the end logical address.

6. The system of claim 1, wherein the operations further comprise:
identifying, among a set of metadata items, a first metadata item and a second metadata item, wherein each of the first metadata item and the second metadata item stores a same IU identifier;
responsive to determining that a combination of a first portion of host data stored by a first cache line associated with the first metadata item and a second portion of host data stored by a second cache line associated with the second metadata item forms an entire IU:
storing, on the memory device, the combination of the first portion of the host data and the second portion of host data; and
invalidating the first cache line and the second cache line.

7. The system of claim 1, wherein the operations further comprise:
identifying, among a set of metadata items, a first metadata item and a second metadata item, wherein each of the first metadata item and the second metadata item stores a same IU identifier;
responsive to determining that a combination of a first portion of host data stored by a first cache line associated with the first metadata item and a second portion of host data stored by a second cache line associated with the second metadata item fails to form an entire IU:
storing, in the first cache line, the combination of the first portion of the host data and the second portion of host data; and
invalidating the second cache line.

8. A method, comprising:
receiving, by a processing device, from a host system, a memory write request specifying a data item to be stored on a memory device managed by the processing device;
identifying a start logical address and an end logical address associated with the data item;
determining that at least one of the start logical address or the end logical address is not aligned with a respective indirection unit (IU);
responsive to determining that the at least one of the start logical address or the end logical address is not aligned with the respective indirection unit (IU), storing a corresponding misaligned portion of the data item in a cache line; and
storing an identifier of the respective IU in a metadata item associated with the cache line.

9. The method of claim 8, wherein a size of the respective IU is a multiple of a size of a system page utilized by the host system.

10. The method of claim 8, wherein the memory write request is comprised by a sequence of memory access requests that is associated with a corresponding processing thread running on the host system.

11. The method of claim 8, wherein the memory write request is comprised by a sequence of memory access requests that is associated with a corresponding submission queue.

12. The method of claim 8, wherein the identifier of the respective IU is determined by applying a predefined mathematical transformation to a corresponding logical address represented by one of: the start logical address or the end logical address.

13. The method of claim 8, further comprising:
identifying, among a set of metadata items, a first metadata item and a second metadata item, wherein each of the first metadata item and the second metadata item stores a same IU identifier;
responsive to determining that a combination of a first portion of host data stored by a first cache line associated with the first metadata item and a second portion of host data stored by a second cache line associated with the second metadata item forms an entire IU:
storing, on the memory device, the combination of the first portion of the host data and the second portion of host data; and
invalidating the first cache line and the second cache line.

14. The method of claim 8, further comprising:
identifying, among a set of metadata items, a first metadata item and a second metadata item, wherein each of the first metadata item and the second metadata item stores a same IU identifier;
cache line associated with the first metadata item and a second portion of host data stored by a second cache line associated with the second metadata item fails to form an entire IU:
storing, in the first cache line, the combination of the first portion of the host data and the second portion of host data; and
invalidating the second cache line.

15. A non-transitory computer-readable storage medium comprising executable instructions that, when executed by a processing device, cause the processing device to perform operations, comprising:
receiving, from a host system, a memory write request specifying a data item to be stored on a memory device managed by the processing device;
identifying a start logical address and an end logical address associated with the data item;
determining that at least one of the start logical address or the end logical address is not aligned with a respective indirection unit (IU);
responsive to determining that the at least one of the start logical address or the end logical address is not aligned with the respective indirection unit (IU), storing a corresponding misaligned portion of the data item in a cache line; and
storing an identifier of the respective IU in a metadata item associated with the cache line.

16. The non-transitory computer-readable storage medium of claim 15, wherein a size of the respective IU is a multiple of a size of a system page utilized by the host system.

17. The non-transitory computer-readable storage medium of claim 15, wherein the memory write request is comprised by a sequence of memory access requests that is associated with a corresponding processing thread running on the host system.

18. The non-transitory computer-readable storage medium of claim 15, wherein the memory write request is comprised by a sequence of memory access requests that is associated with a corresponding submission queue.

19. The non-transitory computer-readable storage medium of claim 15 wherein the operations further comprise:
identifying, among a set of metadata items, a first metadata item and a second metadata item, wherein each of the first metadata item and the second metadata item stores a same IU identifier;
responsive to determining that a combination of a first portion of host data stored by a first cache line associated with the first metadata item and a second portion of host data stored by a second cache line associated with the second metadata item forms an entire IU:
storing, on the memory device, the combination of the first portion of the host data and the second portion of host data; and
invalidating the first cache line and the second cache line.

20. The non-transitory computer-readable storage medium of claim 15, wherein the operations further comprise:
identifying, among a set of metadata items, a first metadata item and a second metadata item, wherein each of the first metadata item and the second metadata item stores a same IU identifier;
responsive to determining that a combination of a first portion of host data stored by a first cache line associated with the first metadata item and a second portion of host data stored by a second cache line associated with the second metadata item fails to form an entire IU:
storing, in the first cache line, the combination of the first portion of the host data and the second portion of host data; and
invalidating the second cache line.
